(19) United States
(12) Patent Application Publication
(10) Pub. No.: US 2017/0116918 A1
(43) Pub. Date: Apr. 27, 2017

(54) PIXEL CIRCUIT AND DRIVING METHOD FOR THE PIXEL CIRCUIT

(71) Applicant: BOE TECHNOLOGY GROUP CO., LTD., Beijing (CN)

(72) Inventors: Tian DONG, Beijing (CN); Yunfei LI, Beijing (CN)

(73) Assignee: BOE TECHNOLOGY GROUP CO., LTD., Beijing (CN)

(21) Appl. No.: 15/037,627

(22) PCT Filed: Sep. 18, 2015
(86) PCT No.: PCT/CN2015/089913

§ 371 Date: May 18, 2016

(30) Foreign Application Priority Data
May 22, 2015 (CN) 201510268476.8

(51) Int. Cl. G09G 3/3233

(52) U.S. Cl. CPC G09G 3/3233; G09G 2320/0233; G09G 2300/0819; G09G 2330/02

(57) ABSTRACT

A pixel circuit, a driving method thereof and related device are disclosed. The pixel circuit comprises a drive transistor, a reset module, a compensation module, a data write module, a light emitting control module and a light emitting device. The reset module is configured to provide a reference signal to a gate electrode of the drive transistor. The compensation module is configured to store a threshold voltage of the drive transistor. The data write module is configured to write a data signal onto the gate electrode of the drive transistor. The light emitting control module is configured to control the drive transistor to drive the light emitting device to emit light. With the pixel circuit above, a drive current for the light emitting device to emit light is only relevant to a voltage of the data signal and a voltage of the reference signal, and irrelevant to the threshold voltage of the drive transistor and a voltage of a first power supply, so that the threshold voltage of the drive transistor and IR drop of the first power supply will not affect the current flowing through the light emitting device, and thus image brightness uniformity of a display area of a display device can be improved.

This application claims the benefit and priority of Chinese Patent Application No. 201510268476.8 filed on May 22, 2015, the entire content of which is incorporated herein by reference.

### TECHNICAL FIELD

The present invention relates to organic electroluminescence technology, and more particularly, to a pixel circuit and driving method thereof.

### BACKGROUND

Organic Light Emitting Diode (OLED) display has been popular for a flat panel display nowadays. Compared to a Liquid Crystal Display (LCD), an OLED display has advantages such as low energy consumption, low production cost, self-luminousness, wide view angle, and quick response speed. At present, in electronic devices such as mobile phone, Personal Digital Assistant (PDA), digital camera, the OLED display has started to replace the traditional LCD display screen. Design of a pixel circuit is one of the essential technologies for the OLED display.

Different from the LCD display which controls lightness by means of a stable voltage, the OLED display is current-driven and thus requires a stable current to control light emitting. Due to reasons such as process production and device aging, a threshold voltage Vₜₕ of a drive transistor in the pixel circuit of the OLED display is uneven, which thus results in that the current that flows through each pixel point varies, which causes the display lightness uneven and thus affects the display effect of the whole image.

FIG. 1 shows an example of an existing pixel circuit for the OLED display. As shown in FIG. 1, the pixel circuit comprises a drive transistor M2, a P-type switching transistor M1 and a storage capacitor Cs. When a scan line Scan is selected, a low level signal is inputted into the scan line Scan, the P-type switching transistor M1 is turned on, and a voltage of the data line Data is stored in the storage capacitor Cs. When the signal inputted into the scan line Scan becomes high level, the P-type switching transistor M1 is turned off, and the voltage stored in the storage capacitor Cs is applied onto the gate electrode of the drive transistor M2, so that the drive transistor M2 generates a current to drive the OLED to ensure the OLED emits light continuously within one frame. The saturation current of the drive transistor M2 is represented as I_{OLED}=K(V_{SG}−Vₜₕ)², where V_{SG} indicates a gate source voltage and Vₜₕ indicates the threshold voltage. As stated above, the threshold voltage Vₜₕ of the drive transistor M2 may drift due to the process production or the device aging. Furthermore, the current is relevant to the voltage of a power supply, and the source voltage Vs may also be different due to IR Drop. Thus, the current that flows through each OLED may change as the threshold voltage Vₜₕ of the drive transistor and the source voltage VDD of the drive transistor change, which thus results in that the image lightness is uneven.

### SUMMARY

Embodiments of the present invention provide a pixel circuit, a driving method for the pixel circuit and a related device so as to improve the evenness of image lightness of the display area of the display device.

According to an embodiment, there is provided a pixel circuit, which comprises a drive transistor, a reset module, a compensation module, a data write module, a light emitting control module and a light emitting device. The reset module comprises a control terminal for receiving a reset control signal, an input terminal for receiving a reference signal, and an output terminal being connected with a gate electrode of the drive transistor. The reset module is configured to provide the reference signal to the gate electrode of the drive transistor under the control of the reset control signal. The compensation module is connected between the gate electrode and a source electrode of the drive transistor. The compensation module is configured to store a threshold voltage of the drive transistor after the reset module provides the reference signal to the gate electrode of the drive transistor. The data write module comprises a control terminal for receiving a write control signal, an input terminal for receiving a data signal, and an output terminal being connected with the gate electrode of the drive transistor. The data write module is configured to write the data signal onto the gate electrode of the drive transistor under the control of the write control signal. The light emitting control module comprises a first input terminal, a second input terminal, a first control terminal, a second control terminal, a first output terminal and a second output terminal. The first input terminal is connected with a first power supply. The second input terminal is connected with a drain electrode of the drive transistor. The first control terminal receives a first light emitting control signal. The second control terminal receives a second light emitting control signal. The first output terminal is connected with the source electrode of the drive transistor. The second output terminal is connected with a terminal of the light emitting device, and the other terminal of the light emitting device is connected with a second power supply. The light emitting control module is configured to turn on the drive transistor and the light emitting device under the control of the first light emitting control signal, when the reset module provides the reference signal to the gate electrode of the drive transistor, and to control the drive transistor to drive the light emitting device to emit light under the control of the first light emitting control signal and the second light emitting control signal, after the data write module writes the data signal onto the gate electrode of the drive transistor.

According to an embodiment, the reset module comprises a first switching transistor. A gate electrode of the first switching transistor receives the reset control signal, a drain electrode of the first switching transistor receives the reference signal, and a source electrode of the first switching transistor is connected with the gate electrode of the drive transistor.

According to an embodiment, the data write module comprises a second switching transistor. A gate electrode of the second switching transistor receives the write control signal, a source electrode of the second switching transistor receives the data signal, and a drain electrode of the second switching transistor is connected with the gate electrode of the drive transistor.

According to an embodiment, the compensation module comprises a first capacitor connected between the gate electrode and the source electrode of the drive transistor.

According to an embodiment, the light emitting control module comprises a third switching transistor, a fourth switching transistor and a second capacitor. A gate electrode of the third switching transistor receives the first light emitting control signal, a source electrode of the third switching transistor is connected with the drain electrode of the drive transistor, and a drain electrode of the third switching transistor is connected with the light emitting device. A gate electrode of the fourth switching transistor receives the second light emitting control signal, a source electrode of the fourth switching transistor is connected with the first power supply, and a drain electrode of the fourth switching transistor is connected with the source electrode of the drive transistor. The second capacitor is connected between the source electrode and the drain electrode of the fourth switching transistor.

According to an embodiment, the drive transistor is a P-type transistor.

According to an embodiment, the first, second, third and fourth switching transistors are P-type transistors.

According to another embodiment, there is provided a driving method for the pixel circuit. In the driving method, the reset module provides a reference signal to the gate electrode of the drive transistor under the control of a reset control signal.

The compensation module stores a threshold voltage of the drive transistor. The light emitting control module turns on the drive transistor and the light emitting device under the control of the first light emitting control signal.

The data write module writes the data signal onto the gate electrode of the drive transistor by under the control of a write control signal.

The light emitting control module controls the drive transistor to drive the light emitting device to emit light under the control of the first light emitting control signal and the second light emitting control signal.

According to still another embodiment, there is provided an organic electroluminescence display panel, which comprises the pixel circuit above.

According to still another embodiment, there is provided a display device, which comprises the organic electroluminescence display panel above.

The pixel circuit according to the embodiments comprises the drive transistor, the reset module, the compensation module, the data write module, the light emitting control module and the light emitting device. The reset module provides a reference signal to the gate electrode of the drive transistor under the control of a reset control signal. The compensation module stores a threshold voltage of the drive transistor after the reset module provides the reference signal to the gate electrode of the drive transistor. The data write module writes a data signal onto the gate electrode of the drive transistor under the control of a write control signal. The light emitting control module turns on the drive transistor and the light emitting device under the control of the first light emitting control signal, when the reset module provides the reference signal to the gate electrode of the drive transistor, and controls the drive transistor to drive the light emitting device to emit light under the control of the first light emitting control signal and the second light emitting control signal, after the data write module writes the data signal onto the gate electrode of the drive transistor. With the pixel circuit according to the embodiments the drive current of the drive transistor for driving the light emitting device to emit light can be only relevant to the voltage of the data signal and the voltage of the reference signal, but irrelevant to the threshold voltage of the drive transistor and the voltage of the first power supply during the display of the pixel circuit, by means of the cooperation of the respective modules above. Thus the threshold voltage of the drive transistor and IR drop of the first power supply would not affect the current flowing through the light emitting device, which keeps the work current of the drive transistor uniform and improves the image brightness uniformity of the display area of the display device.

### BRIEF DESCRIPTION OF THE DRAWINGS

To illustrate the embodiments more clearly, drawings will be briefly described below. A person skilled in the art will appreciate that the drawings described below merely relate to some embodiments of the present invention, other than limitations to the present invention, in which:

FIG. 1 is a schematic diagram of an example of the existing pixel circuit;

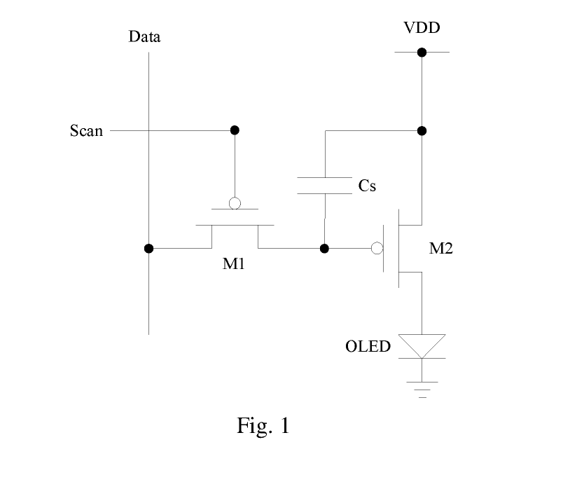

FIG. 2 is a schematic block diagram of the pixel circuit according to an embodiment;

FIG. 3a is a circuit diagram of the pixel circuit according to one embodiment;

FIG. 3b is a circuit diagram of the pixel circuit according to another embodiment;

FIG. 4a is a schematic timing diagram of the input signals of the pixel circuit shown in FIG. 3a;

FIG. 4b is a schematic timing diagram of the input signals of the pixel circuit shown in FIG. 3b; and

FIG. 5 is a schematic flow chart of the driving method for the pixel circuit according to an embodiment.

### DETAILED DESCRIPTION

In order to make the objective, technical solution and advantages of the embodiments more apparent, the technical solutions of the embodiments will be described in detail in conjunction with the drawings below. Apparently, the described embodiments are part of the embodiments, rather than all of the embodiments. On the basis of the embodiments, all other embodiments obtained by those skilled in the art are within the scope of the present disclosure.

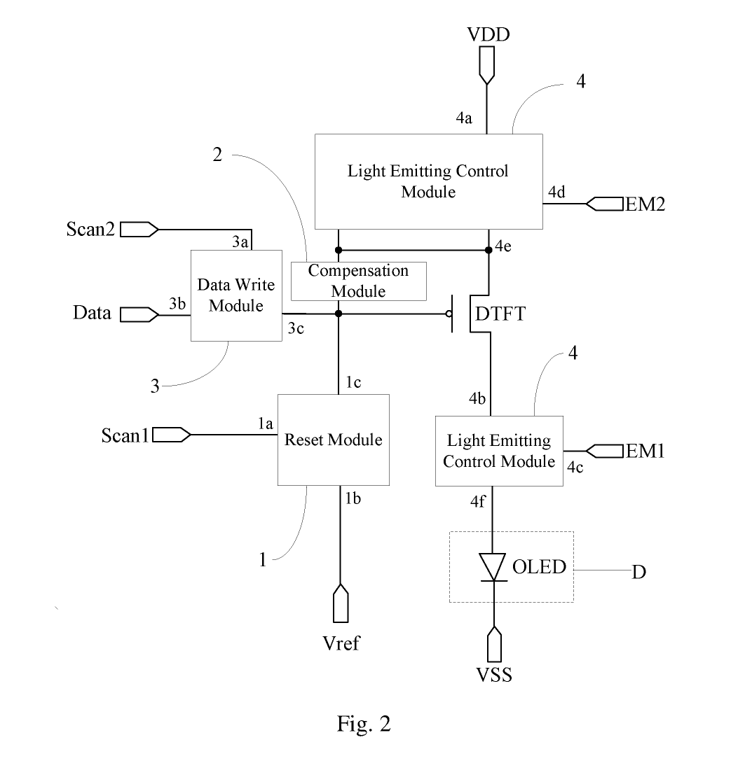

FIG. 2 shows the pixel circuit according to an embodiment of the present disclosure. As shown in FIG. 2, the pixel circuit comprises a drive transistor DTFT, a reset module 1, a compensation module 2, a data write module 3, a light emitting control module 4 and a light emitting device D.

The reset module 1 includes a control terminal 1a, an input terminal 1b and an output terminal 1c. The control terminal 1a may receive a reset control signal Scan1, the input terminal 1b may receive a reference signal Vref, and an output terminal 1c is connected with a gate electrode of the drive transistor DTFT. The reset module 1 may provide the reference signal Vref to the gate electrode of the drive transistor DTFT under the control of the reset control signal Scan1.

The compensation module 2 is connected between the gate electrode of the drive transistor DTFT and a source electrode of the drive transistor DTFT. The compensation module 2 may store a threshold voltage Vₜₕ of the drive transistor DTFT, after the reset module 1 provides the reference signal Vref to the gate electrode of the drive transistor DTFT.

The data write module 3 includes a control terminal 3a, an input terminal 3b and an output terminal 3c. The control terminal 3a may receive a write control signal Scan2, the input terminal 3b may receive a data signal Data, and the output terminal 3c is connected with the gate electrode of the drive transistor DTFT. The data write module 3 may write the data signal Data onto the gate electrode of the drive transistor DTFT under the control of the write control signal Scan2.

The light emitting control module 4 includes a first input terminal 4a, a second input terminal 4b, a first control terminal 4c, a second control terminal 4d, a first output terminal 4e and a second output terminal 4f. The first input terminal 4a is connected with a first power supply VDD, and the second input terminal 4b is connected with a drain electrode of the drive transistor DTFT. The first control terminal 4c may receive a first light emitting control signal EM1, and the second control terminal 4d may receive a second light emitting control signal EM2. The first output terminal 4e is connected with the source electrode of the drive transistor DTFT, and the second output terminal 4f is connected with a terminal of the light emitting device D. The other terminal of the light emitting device D is connected with a second power supply VSS. The light emitting control module 4 may turn on the drive transistor DTFT and the light emitting device D under the control of the first light emitting control signal EM1, when the reset module 1 provides the reference signal Vref to the gate electrode of the drive transistor DTFT. The light emitting control module 4 may control the drive transistor DTFT to drive the light emitting device D to emit light under the control of the first light emitting control signal EM1 and the second light emitting control signal EM2, after the data write module 3 writes the data signal Data onto the gate electrode of the drive transistor DTFT.

In the pixel circuit according to the embodiment, the reference signal is provided by the reset module to the gate electrode of the drive transistor, the compensation module stores the threshold voltage of the drive transistor, the data write module writes the data signal onto the gate electrode of the drive transistor, the light emitting control module turns on the drive transistor and the light emitting device under the control of the first light emitting control signal, and controls the drive transistor to drive the light emitting device to emit light under the control of the first and second light emitting control signals. With the pixel circuit according to the embodiment, the drive current of the drive transistor for driving the light emitting device to emit light can be only relevant to the voltage of the data signal and the voltage of the reference signal, but irrelevant to the threshold voltage of the drive transistor and the voltage of a first power supply, during the display of the pixel circuit. Thus the threshold voltage of the drive transistor and IR drop of the first power supply would not affect the current flowing through the light emitting device, which keeps the work current of the drive transistor uniform and improves the image brightness uniformity of the display area of the display device.

Next the specific implementations of the pixel circuit according to the embodiments of the present disclosure will be described in detail. It should be noted that these specific implementations are illustrative of the embodiments of the present disclosure and shall not be construed as limitations.

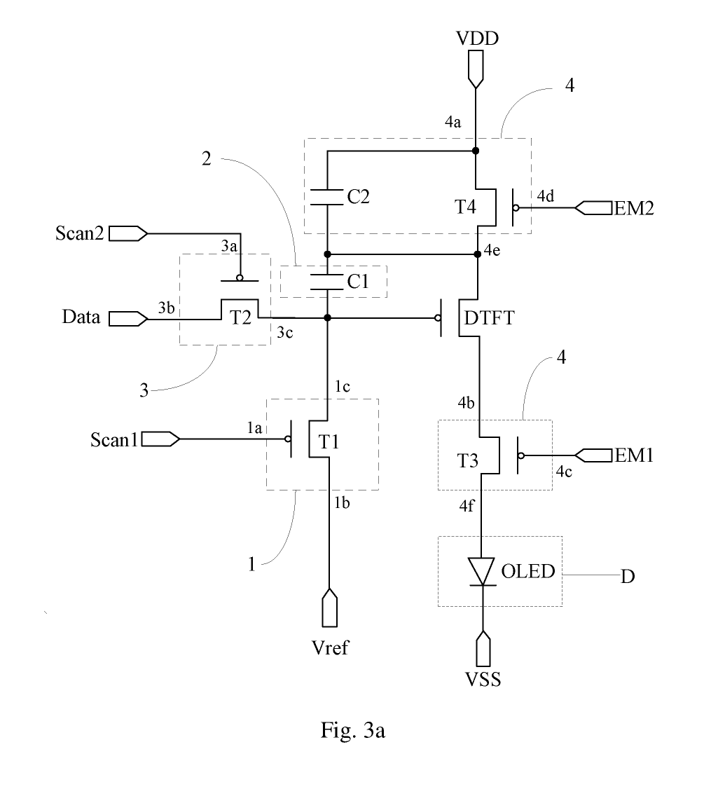

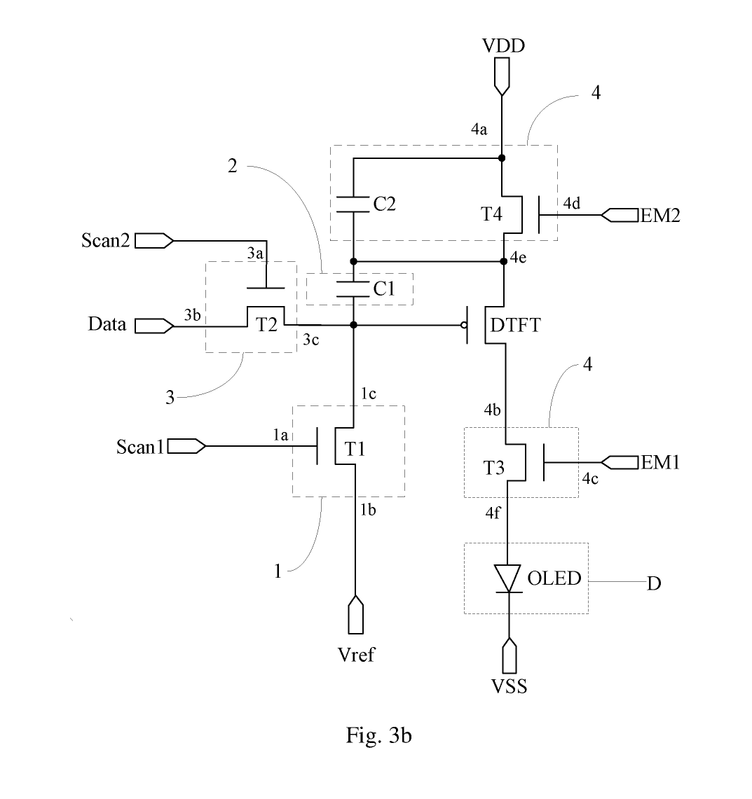

FIG. 3a and FIG. 3b show the exemplary circuit diagrams of the pixel circuit according to different embodiments, and the difference is to use different types of transistor.

In the pixel circuits according to the embodiments, the drive transistor DTFT may be a P-type transistor. The P-type transistor comprises enhancement P-type transistor and depletion P-type transistor. The pixel circuit using any type of P-type transistor as the drive transistor may have the functions of compensating the threshold voltage and IR drop.

Moreover, in the pixel circuits according to the embodiments, as the threshold voltage of the P-type transistor is generally a negative value, the voltage of the first power supply VDD is generally a positive voltage and the voltage of the second power supply VSS is generally grounded or a negative voltage, so as to ensure the drive transistor DTFT operates normally.

It should be noted that, in the pixel circuits according to the embodiments of the present disclosure, the voltage Vr of the reset signal Vref and the voltage Vdd of the first power supply VDD shall meet the following condition, i.e. Vdd>Vr−Vₜₕ, where Vₜₕ is the threshold voltage of the drive transistor DTFT. In the implementation, a range of compensation to the threshold voltage Vₜₕ may be adjusted by adjusting the voltage Vdd of the first power supply VDD and the voltage Vr of the reset signal Vref. Moreover, the working range of the voltage Vdata of the data signal Data is relevant to the voltage Vr of the reset signal Vref, where the higher Vr is, the greater the minimum value of Vdata is.

Further, in the pixel circuits according to the embodiments, the light emitting device D may be an organic light emitting diode OLED. As shown in FIGS. 3a and 3b, an anode of the organic light emitting diode OLED is connected with the light emitting control module 4, and a cathode thereof is connected with the second power supply VSS. The organic light emitting diode OLED may be driven by a saturation current of the drive transistor DTFT to implement the light emitting.

Referring to FIGS. 3a and 3b, the reset module 1 may comprise a first switching transistor T1. The gate electrode 1a of the first switching transistor T1 receives the reset control signal Scan1, the drain electrode 1b of the first switching transistor T1 receives the reference signal Vref, and the source 1c of the first switching transistor T1 is connected with the gate electrode of the drive transistor DTFT.

In FIG. 3a, the first switching transistor T1 is a P-type transistor. In this case, when the reset control signal Scan1 is at low level, the first switching transistor T1 is turned on. When the reset control signal Scan1 is at high level, the first switching transistor T1 is turned off. In FIG. 3b, the first switching transistor T1 is an N-type transistor. In this case, when the reset control signal Scan1 is at high level, the first switching transistor T1 is turned on. When the reset control signal Scan1 is at low level, the first switching transistor T1 is turned off.

In the case that the first switching transistor T1 is turned on under the control of the reset control signal Scan1, the reference signal Vref is provided by the first switching transistor T1 to the gate electrode of the drive transistor DTFT so as to reset the gate electrode of the drive transistor DTFT.

Although an exemplary implementation of the reset module 1 in the pixel circuit is provided herein, those skilled in the art will appreciate that the reset module 1 is not limited to this example and may have other structures.

Referring to FIGS. 3a and 3b, the data write module 3 may comprise a second switching transistor T2. The gate electrode 3a of the second switching transistor T2 receives a write control signal Scan2, the source 3c of the second switching transistor T2 receives the data signal Data, and the drain electrode 3c of the second switching transistor T2 is connected with the gate electrode of the drive transistor DTFT.

In FIG. 3a, the second switching transistor T2 is a P-type transistor. In this case, when the write control signal Scan2 is at low level, the second switching transistor T2 is turned on. When the write control signal Scan2 is at high level, the second switching transistor T2 is turned off. In FIG. 3b, the second switching transistor T2 is an N-type transistor. In this case, when the write control signal Scan2 is at high level, the second switching transistor T2 is turned on. When the write control signal Scan2 is at low level, the second switching transistor T2 is turned off.

When the second switching transistor T2 is turned on under the control of the write control signal Scan2, the data signal Data is transferred to the gate electrode of the drive transistor DTFT by the second switching transistor T2.

Although an exemplary implementation of the data write module 3 in the pixel circuit is provided herein, those skilled in the art will appreciate that the data write module 3 is not limited to this example and may have other structures.

Referring to FIGS. 3a and 3b again, the compensation module 2 may comprise a first capacitor C1 connected between the gate electrode and the source electrode of the drive transistor DTFT. When the first switching transistor T1 is turned on under the control of the reset control signal Scan1, the reset signal Vref is provided to the gate electrode of the drive transistor DTFT by the first switching transistor T1, and the drive transistor DTFT is turned on. The light emitting control module 4 turns on the drive transistor and the light emitting device under the control of the first light emitting control signal EM1. The first capacitor C1 starts to charge until a difference between the voltages at two terminals of the first capacitor C1 equals to the threshold voltage of the drive transistor DTFT. Thus, the threshold voltage of the drive transistor DTFT is stored on the first capacitor C1 so as to compensate the threshold voltage of the drive transistor DTFT.

Although an exemplary implementation of the compensation module 2 in the pixel circuit is provided herein, those skilled in the art will appreciate that the compensation module 2 is not limited to this example and may have other structures.

Moreover, referring to FIGS. 3a and 3b, the light emitting control module 4 may comprise a third switching transistor T3, a fourth switching transistor T4 and a second capacitor C2. A gate electrode 4c of the third switching transistor T3 receives the first light emitting control signal EM1, a source electrode 4b of the third switching transistor T3 is connected with the drain electrode of the drive transistor DTFT, and a drain electrode 4f of the third switching transistor T3 is connected with the light emitting device D. A gate electrode 4d of the fourth switching transistor T4 receives the second light emitting control signal EM2, a source electrode 4a of the fourth switching transistor T4 is connected with the first power supply VDD, and a drain electrode 4e of the fourth switching transistor T4 is connected with the source electrode of the drive transistor DTFT. The second capacitor C2 is connected between the source electrode 4a and the drain electrode 4e of the fourth switching transistor T4.

In FIG. 3a, the third switching transistor T3 is a P-type transistor. In this case, when the first light emitting control signal EM1 is at low level, the third switching transistor T3 is turned on. When the first light emitting control signal EM1 is at high level, the third switching transistor T3 is turned off. In FIG. 3b, the third switching transistor T3 is an N-type transistor. In this case, when the first light emitting control signal EM1 is at high level, the third switching transistor T3 is turned on. When the first light emitting control signal EM1 is at low level, the third switching transistor T3 is turned off.

Furthermore, in FIG. 3a, the fourth switching transistor T4 is a P-type transistor. In this case, when the second light emitting control signal EM2 is at low level, the fourth switching transistor T4 is turned on. When the second light emitting control signal EM2 is at high level, the fourth switching transistor T4 is turned off. In FIG. 3b, the fourth switching transistor T4 is an N-type transistor. In this case, when the second light emitting control signal EM2 is at high level, the fourth switching transistor T4 is turned on. When the second light emitting control signal EM2 is at low level, the fourth switching transistor T4 is turned off.

In the pixel circuit as shown in FIG. 3a or FIG. 3b, when the reset module 1 provides the reference signal Vref to the gate electrode of the drive transistor DTFT, the third switching transistor T3 is turned on under the control of the first light emitting control signal EM1, and the drive transistor DTFT is turned on. Thus, the threshold voltage of the drive transistor DTFT may be stored on the first capacitor C1. After the data write module 3 provides the data signal Data to the gate electrode of the drive transistor DTFT, the third switching transistor T3 is turned on under the control of the first light emitting control signal EM1, and meanwhile the fourth switching transistor T4 is turned on under the control of the second light emitting control signal EM2. The first power supply VDD and the second power supply VSS are turned on by the third switching transistor T3, the drive transistor DTFT and the fourth switching transistor T3 and the light emitting device, so that the drive transistor DTFT may drive the light emitting device D to emit light. In the process of emitting light, due to the first capacitor C1, the drive voltage is irrelevant to the threshold voltage of the drive transistor. Furthermore, due to the combination of the first capacitor C1 and the second capacitor C2, the drive current is also irrelevant to the voltage of the first power supply VDD. Thus, the threshold voltage of the drive transistor DTFT and IR drop of the first power supply VDD would not affect the current flowing through the light emitting device D, which keeps the work current of the drive transistor DTFT uniform and improves the image brightness uniformity of the display area of the display device.

Although an exemplary implementation of the light emitting control module 4 in the pixel circuit is provided, those skilled in the art will appreciate that the light emitting control module 4 is not limited to this example and may have other structures.

With the pixel circuit according to the embodiments of the present disclosure, the first and second capacitors C1, C2, the first, second, third, and fourth switching transistor T1, T2, T3, T4, and the drive transistor DTFT can cooperate with each other, so as to compensate the drift of the threshold voltage of the drive transistor DTFT and the IR drop. Therefore the work current that make the drive transistor DTFT drive the light emitting device D to emit light is only relevant to the voltage Vdata of the data signal Data and the voltage Vr of the reference signal Vref, and is irrelevant to the threshold voltage of the drive transistor DTFT and the first power supply VDD, during the display, so that the threshold voltage and IR drop of the first power supply would not affect the current flowing through the light emitting device D, which keeps the work current that drives the light emitting device D to emit light uniform and improves the image brightness uniformity of the display area of the display device.

Those skilled in the art will appreciate that the drive transistor and switching transistor mentioned in the previous embodiments may be either a thin film transistor TFT or a Metal Oxide Semiconductor (MOS) field effect transistor.

In order to simplify the production process, in the pixel circuit according to any embodiment of the present invention, all of the first, second, third and fourth switching transistors may be P-type transistor or N-type transistor.

Furthermore, as the drive transistor DTFT is a P-type transistor, the first, second, third and fourth switching transistors may also be a P-type transistor to simplify the production process of the pixel circuit.

Next the work process of the pixel circuits as shown in FIG. 3a and FIG. 3b, for example, will be described in detail. In the description below, “1” indicates the high level signal and “0” indicates the low level signal.

Example 1: work process of the pixel circuit as shown in FIG. 3a.

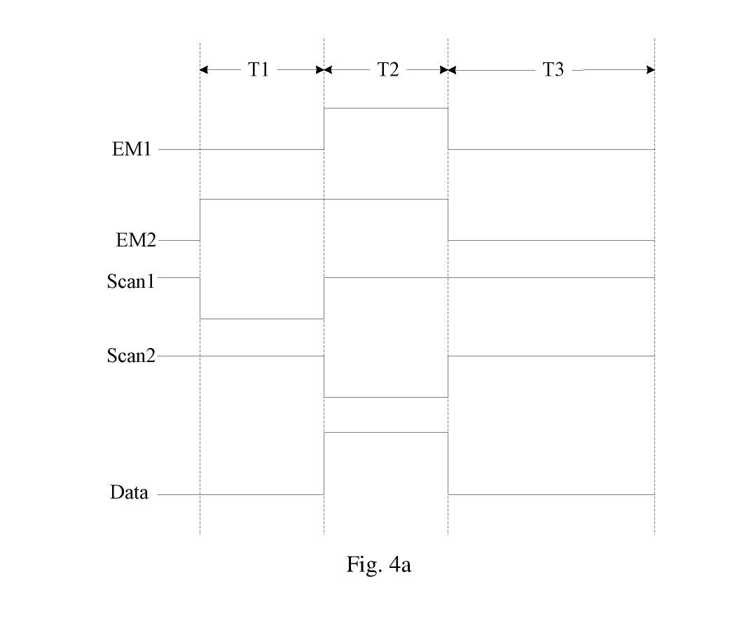

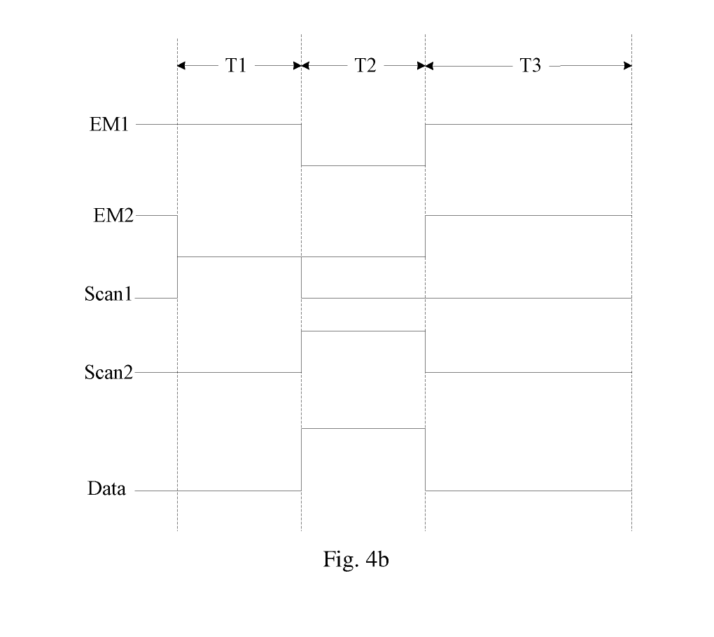

In the pixel circuit as shown in FIG. 3a, the drive transistor DTFT and all of the first, second, third and fourth switching transistors are P-type transistors. The P-type transistors are turned off under the high level signal and turned on under the low level signal. FIG. 4 shows the timing diagram of the input signals of the pixel circuit. The work process of the pixel circuit in the three phases of T1, T2 and T3 will be described specifically below.

In T1 phase, Scan1=0, Scan2=1, EM1=0, and EM2=1. The first switching transistor T1 and the third switching transistor T3 are turned on, and the gate voltage of the drive transistor DTFT equals to the voltage Vr of the reference signal Vref. The first capacitor C1 starts to charge until the difference between the voltages at the two terminals of the first capacitor C1 is equal to the threshold voltage Vₜₕ of the drive transistor DTFT. At this time, the gate voltage of the drive transistor DTFT equals to Vr and the source voltage of the drive transistor DTFT equals to (Vr−Vₜₕ).

In T2 phase, Scan1=1, Scan2=0, EM1=1, and EM2=1. The second switching transistor T2 is turned on, and the gate voltage of the drive transistor DTFT becomes the voltage Vdata of the data signal Data. According to law of conservation of charge as well as voltage division by the first and second capacitors C1, C2, the source voltage of the drive transistor DTFT becomes (Vr−Vₜₕ+(c1/(c1+c2)×(Vdata−Vr))), where c1 and c2 represent capacitance values of the first capacitor C1 and the second capacitor C2 respectively.

In T3 phase, Scan1=1, Scan2=1, EM1=0, and EM2=0. The third switching transistor T3 and the fourth switching transistor T4 are turned on, and the source voltage of the drive transistor DTFT becomes the voltage Vdd of the first power supply VDD. According to law of conservation of charge, the gate voltage of the drive transistor DTFT changes from Vdata in the previous phase to ((c2/(c1+c2)×(Vdata−Vr)+Vdd+Vₜₕ). In this phase, the drive transistor DTFT is in saturation state. According to the current characteristic of the saturation state, the work current I_{OLED} that flows through the drive transistor DTFT and drives Organic Light Emitting Diode OLED to emit light may be calculated as:

$$\begin{matrix}{I}_{OLED} = K \times {( {V}_{gs} - {V}_{th} )}^{2} \\ = K \times ( c 2 / ( c 1 + c 2 ) ) \times \\ { ( Vdata - Vr ) + Vdd + {V}_{th} - Vdd - {V}_{th} )}^{2} \\ = K \times {( c 2 \times ( Vdata - Vr ) / ( c 1 + c 2 ) )}^{2} ,\end{matrix}$$

where K represents a structure parameter. In the same structure, the value of K is relatively stable and may be considered as a constant. It can be therefore seen that the work current I_{OLED} of the Organic Light Emitting Diode OLED would not be affected by the threshold voltage Vₜₕ of the drive transistor DTFT, and is irrelevant to the voltage Vdd of the first power supply VDD while is only relevant to the voltage Vdata of the data signal Data and the voltage Vr of the reference signal Vref, so that the drift of the threshold voltage of the drive transistor caused by the process production and long-term operation as well as IR drop of the first power supply would not affect the work current of the light emitting device D, which improves the display unevenness of the display area.

Example 2: work process of the pixel circuit as shown in FIG. 3b.

In the pixel circuit as shown in FIG. 3b, the drive transistor DTFT is the P-type transistor and all of the switching transistors T1, T2, T3, and T4 are N-type transistors. The P-type transistor is turned off under the high level signal and turned on under the low level signal. The N-type transistor is turned off under the low level signal and turned on under the high level signal. FIG. 4b shows the timing diagram of the input signals of the pixel circuit. The work process of the pixel circuit in the three phases of T1, T2 and T3 will be described specifically below.

In T1 phase, Scan1=1, Scan2=0, EM1=1, and EM2=0. The first switching transistor T1 and the third switching transistor T3 are turned on, and the gate voltage of the drive transistor DTFT equals to the voltage Vr of the reference signal Vref. The first capacitor C1 starts to charge until the difference between the voltages at the two terminals of the first capacitor C1 is equal to the threshold voltage Vₜₕ of the drive transistor DTFT. At this time, the gate voltage of the drive transistor DTFT equals to Vr and the source voltage of the drive transistor DTFT equals to (Vr−Vₜₕ).

In T2 phase, Scan1=0, Scan2=1, EM1=0, and EM2=0. The second switching transistor T2 is turned on, and the gate voltage of the drive transistor DTFT becomes the voltage Vdata of the data signal Data. According to law of conservation of charge as well as voltage division by the first capacitor C1 and the second capacitor C2, the source voltage of the drive transistor DTFT becomes (Vr−Vₜₕ+(C1/(C1+c2)×(Vdata−Vr))), where c1 and c2 represent capacitance values of the first capacitor C1 and the second capacitor C2 respectively.

In T3 phase, Scan1=0, Scan2=0, EM1=1, and EM2=1. The third switching transistor T3 and the fourth switching transistor T4 are turned on, and the source voltage of the drive transistor DTFT becomes the voltage Vdd of the first power supply VDD. According to law of conservation of charge, the gate voltage of the drive transistor DTFT changes from Vdata in the previous phase to ((c2/(c1+c2)×(Vdata-Vr)+Vdd+Vₜₕ). In this phase, the drive transistor DTFT is in saturation state. According to the current characteristic of the saturation state, the work current I_{OLED} that flows through the drive transistor DTFT and drives Organic Light Emitting Diode OLED to emit light may be calculated as:

$$\begin{matrix}{I}_{OLED} = K \times {( {V}_{gs} - {V}_{th} )}^{2} \\ = K \times ( c 2 / ( c 1 + c 2 ) ) \times \\ { ( Vdata - Vr ) + Vdd + {V}_{th} - Vdd - {V}_{th} )}^{2} \\ = K \times {( c 2 \times ( Vdata - Vr ) / ( c 1 + c 2 ) )}^{2} ,\end{matrix}$$

where K represents a structure parameter. In the same structure, the value of K is relatively stable and may be considered as a constant. It can be therefore seen that the work current I_{OLED} of the Organic Light Emitting Diode OLED would not be affected by the threshold voltage Vₜₕ of the drive transistor DTFT, and is irrelevant to the voltage Vdd of the first power supply VDD while is only relevant to the voltage Vdata of the data signal Data and the voltage Vr of the reference signal Vref, so that the drift of threshold voltage of the drive transistor caused by the process production and long-term operation as well as IR drop of the first power supply would not affect the work current of the light emitting device D, which improves the display unevenness of the display area.

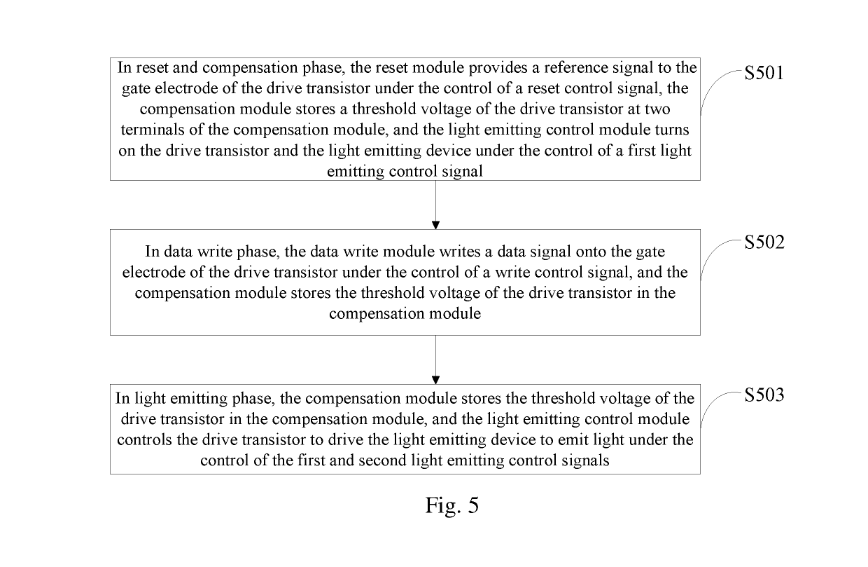

Under the same inventive concept, FIG. 5 shows a driving method for the pixel circuit according to an embodiment of the present disclosure.

As shown in FIG. 5, at step S501, the reset module 1 provides the reference signal Vref to the gate electrode of the drive transistor DTFT under the control of the reset control signal Scan1. Then, the compensation module 2 stores the threshold voltage of the drive transistor DTFT, and the light emitting control module 4 turns on the drive transistor DTFT and the light emitting device D under the control of the first light emitting control signal EM1. Step S501 represents reset and compensation phase.

At step S502, the data write module 3 writes the data signal Data onto the gate electrode of the drive transistor DTFT under the control of the write control signal Scan2. At this time, the compensation module 2 still stores the threshold voltage of the drive transistor DTFT. Step S502 represents data write phase.

At step S503, the compensation module 2 still stores the threshold voltage of the drive transistor DTFT, and the light emitting control module 4 controls the drive transistor DTFT to drive the light emitting device D to emit light under the control of the first light emitting control signal EM1 and the second light emitting control signal EM2. Step S503 represents light emitting phase.

Under the same inventive concept, an embodiment of the present disclosure further provides an organic electroluminescence display panel. The panel comprises the pixel circuit according to the previous embodiments of the present disclosure. As the work principle of the organic electroluminescence display panel is similar to that of the pixel circuit, the implementation of the pixel circuit in the organic electroluminescence display panel may refer to the implementation of the pixel circuit as described in the embodiments above, and its description will be properly omitted.

Under the same inventive concept, an embodiment of the present disclosure further provides a display device. The display device comprises the organic electroluminescence display panel as describe above. The display device may be a display, a mobile phone, a television set, a notebook computer or an all-in-one computer, etc. Other components of the display device are known for those skilled in the art, and their description will be omitted here. Furthermore, these components shall not be construed as limitations to the present disclosure.

Several embodiments of the present disclosure have been described above. However, those skilled in the art may make any modification and variation to these embodiments without departing from the spirit and principle of the present disclosure. All such modifications and variations are intended to be included in the scope of the present disclosure, which is defined by the appended claims.

1. A pixel circuit comprising: a drive transistor, a reset module, a compensation module, a data write module, a light emitting control module and a light emitting device,
wherein the reset module comprises a control terminal for receiving a reset control signal, an input terminal for receiving a reference signal, and an output terminal being connected with a gate electrode of the drive transistor, and is configured to provide the reference signal to the gate electrode of the drive transistor under the control of the reset control signal,
wherein the compensation module is connected between the gate electrode and a source electrode of the drive transistor and is configured to store a threshold voltage of the drive transistor after the reset module provides the reference signal to the gate electrode of the drive transistor,
wherein the data write module comprises a control terminal for receiving a write control signal, an input terminal for receiving a data signal, and an output terminal being connected with the gate electrode of the drive transistor, and is configured to write the data signal onto the gate electrode of the drive transistor under the control of the write control signal,
wherein the light emitting control module comprises a first input terminal, a second input terminal, a first control terminal, a second control terminal, a first output terminal and a second output terminal, wherein the first input terminal is connected with a first power supply, the second input terminal is connected with a drain electrode of the drive transistor, the first control terminal receives a first light emitting control signal, the second control terminal receives a second light emitting control signal, the first output terminal is connected with the source electrode of the drive transistor, the second output terminal is connected with a terminal of the light emitting device, and the other terminal of the light emitting device is connected with a second power supply, and
wherein the light emitting control module is configured to turn on the drive transistor and the light emitting device under the control of the first light emitting control signal, when the reset module provides the reference signal to the gate electrode of the drive transistor, and to control the drive transistor to drive the light emitting device to emit light under the control of the first light emitting control signal and the second light emitting control signal, after the data write module writes the data signal onto the gate electrode of the drive transistor.

2. The pixel circuit according to claim 1, wherein the reset module comprises a first switching transistor, wherein a gate electrode of the first switching transistor receives the reset control signal, a drain electrode of the first switching transistor receives the reference signal, and a source electrode of the first switching transistor is connected with the gate electrode of the drive transistor.

3. The pixel circuit according to claim 1, wherein the data write module comprises a second switching transistor, wherein a gate electrode of the second switching transistor receives the write control signal, a source electrode of the second switching transistor receives the data signal, and a drain electrode of the second switching transistor is connected with the gate electrode of the drive transistor.

4. The pixel circuit according to claim 1, wherein the compensation module comprises a first capacitor connected between the gate electrode and the source electrode of the drive transistor.

5. The pixel circuit according to claim 1, wherein the light emitting control module comprises a third switching transistor, a fourth switching transistor and a second capacitor,
wherein a gate electrode of the third switching transistor receives the first light emitting control signal, a source electrode of the third switching transistor is connected with the drain electrode of the drive transistor, and a drain electrode of the third switching transistor is connected with the light emitting device,
wherein a gate electrode of the fourth switching transistor receives the second light emitting control signal, a source electrode of the fourth switching transistor is connected with the first power supply, and a drain electrode of the fourth switching transistor is connected with the source electrode of the drive transistor, and
wherein the second capacitor is connected between the source electrode and the drain electrode of the fourth switching transistor.

6. The pixel circuit according to claim 1, wherein the drive transistor is a P-type transistor.

7. The pixel circuit according to claim 2, wherein the drive transistor is a P-type transistor, and wherein the first switching transistor is a P-type transistor.

8. A driving method for the pixel circuit according to claim 1, comprising:
providing, by the reset module, a reference signal to the gate electrode of the drive transistor under the control of a reset control signal;
storing, by the compensation module, a threshold voltage of the drive transistor;
turning on the drive transistor and the light emitting device by the light emitting control module under the control of a first light emitting control signal;
writing by the data write module, a data signal onto the gate electrode of the drive transistor under the control of a write control signal; and
controlling, by the light emitting control module, the drive transistor to drive the light emitting device to emit light under the control of the first light emitting control signal and a second light emitting control signal.

9. An organic electroluminescence display panel comprising the pixel circuit according to claim 1.

10. A display device comprising the organic electroluminescence display panel according to claim 9.

11. The pixel circuit according to claim 3, wherein the drive transistor is a P-type transistor, and wherein the second switching transistor is a P-type transistor.

12. The pixel circuit according to claim 5, wherein the drive transistor is a P-type transistor, and wherein the third and fourth switching transistors are P-type transistors.
